(19) United States
(12) Patent Application Publication
(10) Pub. No.: US 2025/0011539 A1
(43) Pub. Date: Jan. 9, 2025

(54) CATALYST HAVING A TRILOBAL GEOMETRY FOR PREPARING POLYTETRAHYDROFURAN

(71) Applicant: BASF SE, Ludwigshafen am Rhein (DE)

(72) Inventors: Veronika Wloka, Ludwigshafen (DE); Thomas Heidemann, Ludwigshafen (DE); Ines Lottenburger, Ludwigshafen (DE)

(73) Assignee: BASF SE, Ludwigshafen am Rhein (DE)

(21) Appl. No.: 18/709,867

(22) PCT Filed: Nov. 16, 2022
(86) PCT No.: PCT/EP2022/082083

§ 371 Date: May 14, 2024

(30) Foreign Application Priority Data
Nov. 17, 2021 (EP) 21208683.9

(51) Int. Cl. C08G 65/20; B01J 21/16; B01J 35/40; B01J 35/50

(52) U.S. Cl. CPC C08G 65/20; B01J 21/16; B01J 35/40; B01J 35/50

(57) ABSTRACT

A process makes polytetrahydrofuran, polytetrahydrofuran copolymers, or the mono- or diesters thereof by polymerizing tetrahydrofuran and any comonomers over shaped catalyst bodies. The catalyst bodies include an acid-activated sheet silicate, where the shaped catalyst bodies have the shape of trilobes. A cross section of the trilobes is bounded by three convex curves that each make contact with a circle of diameter d that circumscribes the cross section and have three points of intersection within said circle. A distance a from any two points of intersection is 0.5 to 0.65 times the diameter d of the circle that circumscribes the cross section.

The invention relates to a process for producing polytetrahydrofuran, polytetrahydrofuran copolymers or the mono- or diesters thereof. The invention further relates to a shaped catalyst body having trilobal geometry and to the use of the shaped catalyst bodies.

Polytetrahydrofuran (PTHF), also called polyoxybutyleneglycol, is a versatile intermediate in the plastics and synthetic fibers industry, and one of its uses is as diol component for production of polyurethane elastomers, polyester elastomers and polyamide elastomers. In addition, like some of its derivatives as well, it is a valuable auxiliary in many applications, for example as dispersant or in the deinking of used paper.

PTHF is typically produced industrially by polymerization of tetrahydrofuran (THF) over suitable catalysts in the presence of chain termination reagents or “telogens”, the addition of which enables control of the chain length of the polymer chains and hence adjustment of the average molecular weight. By choice of suitable telogens, it is additionally possible to introduce functional groups at one end or both ends of the polymer chain.

For example, by use of carboxylic acids or carboxylic anhydrides as telogens, it is possible to produce the mono- or diesters of PTHF. It is only by subsequent hydrolysis or transesterification that PTHF itself is formed. Therefore, this mode of production is referred to as the two-stage PTHF method.

Other telogens not only act as chain termination reagents but are also incorporated into the growing polymer chain of PTHF. Not only do they have the function of a telogen, but they are simultaneously a comonomer. Examples of such comonomers are telogens having two hydroxyl groups, such as dialcohols. These may, for example, be ethylene glycol, propylene glycol, butylene glycol, propane-1,3-diol, butane-1,4-diol, 2-butyne-1,4-diol, 2,2-dimethylpropane-1,3-diol, hexane-1,6-diol or low molecular weight PTHF.

Further suitable comonomers are cyclic ethers, preferably tri-, tetra- and pentacyclic rings, such as 1,2-alkylene oxide, e.g. ethylene oxide or propylene oxide, oxetane, substituted oxetanes, such as 3,3-dimethyloxetane, and THF derivatives, for example 3-methyltetrahydrofuran, 3,3-dimethyltetrahydrofuran or 3,4-dimethyltetrahydrofuran.

The use of such comonomers or telogens, with the exception of water, butane-1,4-diol and low molecular weight PTHF, leads to production of tetrahydrofuran copolymers.

PTHF can be produced industrially in one stage by THF polymerization with water, butane-1,4-diol or low molecular weight PTHF as telogen over acidic catalysts. Known catalysts are both homogeneous systems dissolved in the reaction system and heterogeneous, i.e. largely undissolved, systems. A disadvantage, however, is the relatively low THF conversions that are achieved in particular in the case of synthesis of PTHF of molecular weight 650 to 3000.

On an industrial scale, predominantly the abovementioned two-stage methods are conducted, in which THF is first polymerized, for example in the presence of fluorosulfonic acid, to give polytetrahydrofuran esters, and these are then hydrolyzed to PTHF. Typically, in this form of THF polymerization, higher THF conversions are achieved than in one-stage methods. Particularly advantageous is THF polymerization in the presence of carboxylic anhydrides, for example acetic anhydride, in the presence of acidic catalysts to give PTHF diacetates, and subsequent transesterification of the PTHF diacetates, for example with methanol, to give PTHF and methyl acetate.

The production of PTHF by THF polymerization in the presence of carboxylic anhydrides and the production of THF copolymers by THF polymerization in the presence of carboxylic anhydrides and cyclic ethers as comonomers over acidic clay minerals are known per se.

DE10 2005 058416 A1 discloses a catalyst for production of PTHF comprising a mixture of an acid-activated sheet silicate with 0.5% up to 10% by weight, based on the sheet silicate, of iron(III) oxide and/or cobalt(II, III) oxide. According to that document, these catalysts may be used in the form of tablets, extrudates, spheres, rings or spall. As well as cylindrical extrudates, it is also possible, for example, to use hollow extrudates, ribbed extrudates, star extrudates or other extrudate forms.

Frequently, the clay minerals are formed to cylindrical extrudates having round cross section, for example with a diameter of 1.5 mm. In production, various catalyst batches are obtained with a certain distribution of extrudate length. This results in reactor charges with a relatively low or relatively high pressure drop. Too broad a distribution of the extrudate length of these standard extrudates or an excessively high fines content are unfavorable. The apparent density of these extrudates is relatively high; the pressure drop—especially when the catalyst bed has settled after a prolonged reactor run time—can rise to excessively high values, such that the catalyst has to be exchanged or the space velocity on the catalyst has to be lowered.

It is an object of the invention to provide a catalyst geometry with which the desired apparent density of the shaped catalyst bodies and hence the desired catalyst charge is achieved in the polymerization reactor without resulting in very high pressure drop values in the reactor.

The object is achieved by a process for producing polytetrahydrofuran, polytetrahydrofuran copolymers or the mono- or diesters thereof by polymerizing tetrahydrofuran and any comonomers over shaped catalyst bodies comprising an acid-activated sheet silicate, wherein the shaped catalyst bodies have the shape of trilobes.

The object is also achieved by shaped catalyst bodies, generally extrudates, in the form of trilobes, wherein the cross section of the trilobes is bounded by three convex curves that each make contact with a circle of diameter d that circumscribes the cross section of the trilobes and have three points of intersection within said circle, where the distance a from any two points of intersection is 0.45 to 0.65 times, preferably 0.5 to 0.65 times, more preferably 0.5 to 0.6 times, the diameter d of the circle. This catalyst geometry, for a given apparent density, results in a particularly low pressure drop.

The cross section of the trilobes is bounded by three (open) intersecting convex curves. Convex curves may be open oval curves, i.e. the segments of closed oval curves. Special cases of closed oval curves are ellipses and circles.

Preferably, the cross section of the trilobes has threefold rotational symmetry.

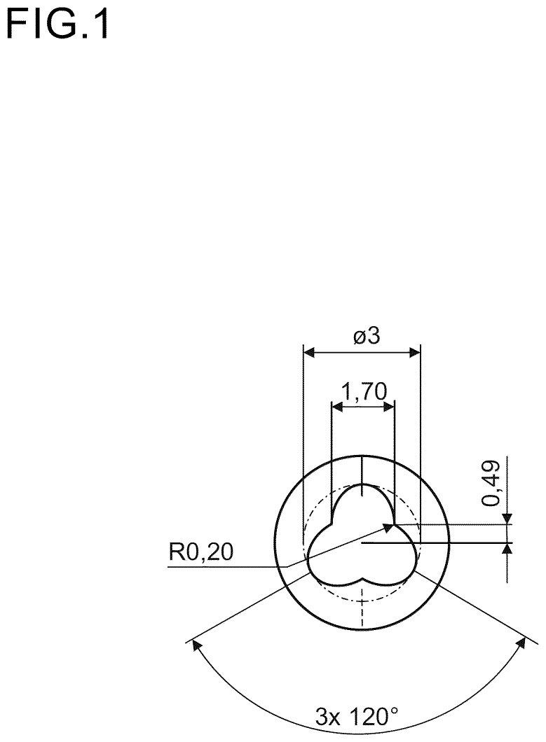

FIG. 1 shows the cross section of one embodiment of trilobal shaped catalyst bodies of the invention. The numerical values shown in the figure give dimensions of the cross section in mm and angles that occur in the trilobe. The dimensions here are d=3 mm and a=1.7 mm. The a:d ratio is accordingly 0.567.

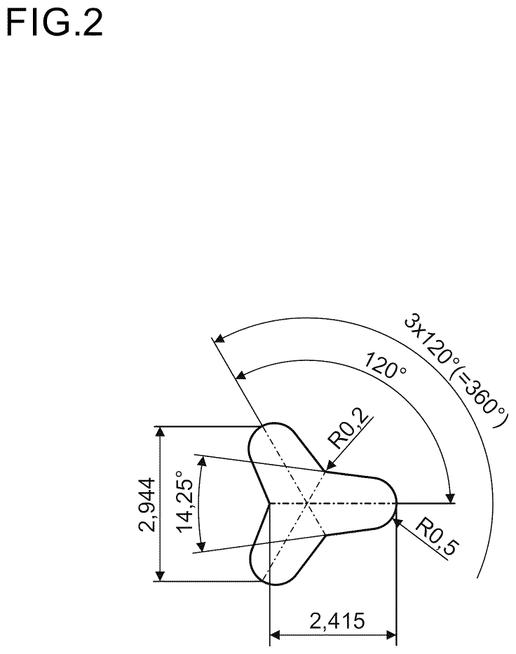

FIG. 2 shows the cross section of comparative trilobes. The numerical values shown in the figure give dimensions of the cross section in mm and angles that occur in the trilobe. The dimensions here are d=3 mm and a=1.2 mm.

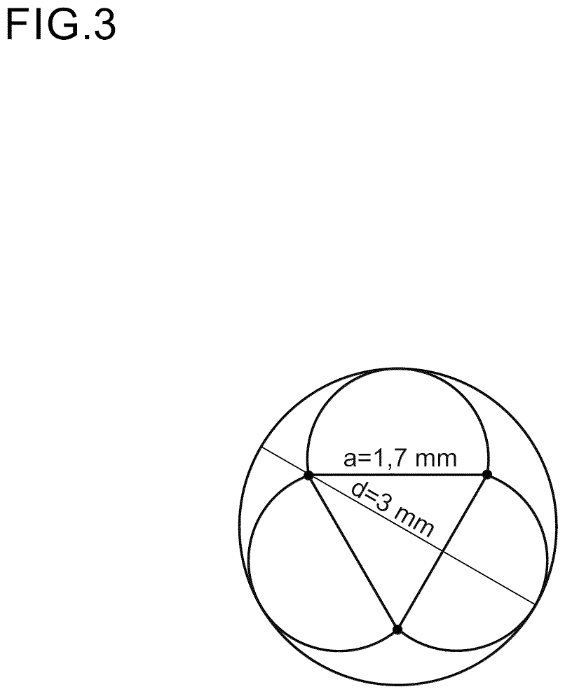

FIG. 3 shows the cross section of a further embodiment of trilobal shaped catalyst bodies of the invention. The dimensions here are d=3 mm and a=1.7 mm. The a:d ratio is accordingly 0.567.

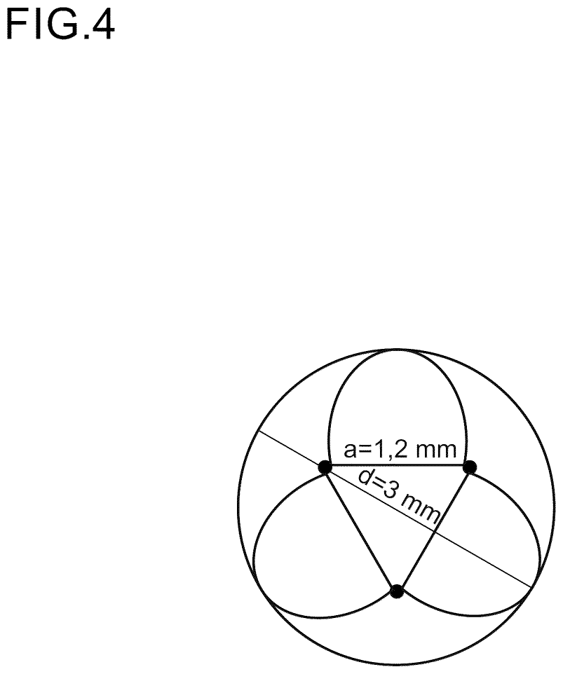

FIG. 4 shows the cross section of further comparative trilobes. The dimensions here ared=3 mm and a=1.2 mm. The a:d ratio is accordingly 0.4.

The diameter d of the circumscribing circle is preferably in the range from 2 to 5 mm, especially in the range from 2.5 to 4 mm. The distance a between the points of intersection is accordingly in the range from preferably 0.9 to 3.25 mm, more preferably 1 to 2.6 mm, and in particular in the range from 1.25 to 2.2 mm.

The ratio of length to diameter d of the trilobal shaped catalyst bodies (extrudates) of the invention is generally 20:1 to 0.5:1, preferably 5:1 to 1:1.

The finished dried and calcined shaped catalyst bodies, preferably extrudates, may differ from the ideal geometry described above. The above details therefore relate in particular also to the opening of the extrusion tools (dies) with which the shaped catalyst bodies of the invention are produced by extrusion. They are obtainable by extrusion through a die having the geometric features described above, followed by drying and calcination.

Acid-activated sheet silicates used may be commercial acid-activated bleaching earths. Examples of these are activated clay minerals of the montmorillonite-saponite group or palygorskite-sepiolite group, more preferably montmorillonites, as described, for example, in Klockmanns Lehrbuch der Mineralogie [Klockmann's Mineralogy Textbook], 16th edition, F. Euke Verlag 1978, pages 739-765. Montmorillonite-containing materials are also referred to as bentonites or occasionally as Fuller's earths.

The acid-activated sheet silicate is preferably selected from the montmorillonite-saponite group or palygorskite-sepiolite group; particular preference is given to montmorillonites. Suitable sources for the sheet silicate are montmorillonite-containing deposits as specified, for example, in “The Economics of Bentonite”, 8th Edition 1997, Roskill Information Services Ltd, London. It is often the case that the raw clays, as well as montmorillonite, also comprise other mineral and nonmineral constituents. Examples of mineral constituents that may be present in different amounts include quartz, feldspar, kaolin, muscovite, zeolites, calcite and/or gypsum.

Preferred sheet silicates have a high montmorillonite content and, accordingly, a low content of secondary constituents. The montmorillonite content can be determined via the determination of methylene blue adsorption by the spotting method according to the information sheet “Bindemittelprüfung/Prüfung von Bindetonen” [Binder Testing/Testing of Binder Clays” from the Verein Deutscher Giessereifachleute [Society of German Foundry Specialists] (VDG, draft P 69 E from June 1998); preferred raw materials show a methylene blue value of >250 mg/g, preferably >290 mg/g, especially >320 mg/g. Particularly preferred sheet silicates are those wherein the exchangeable cations consist of alkali metals in a high percentage, especially sodium. Based on charge equivalents, these raw materials comprise >25%, preferably >40%, of monovalent exchangeable cations.

These sodium bentonites are naturally occurring as raw materials; there are known sources of sodium-containing bentonites, for example, in Wyoming, USA, or in India; they are also known by their origin as “Western bentonites” or “Wyoming bentonites”, or by their properties as “swelling bentonites”. Bentonites having a high proportion of alkaline earth metal cations, especially calcium, are known, for example, as “sub-bentonites” or “Southern bentonites”, and can be converted to sodium-containing bentonites by alkaline activation. Such alkali-activated raw materials are also suitable for catalysts of the invention. Finally, it is also possible in principle to synthetically produce suitable raw materials.

Sheet silicates of natural origin occasionally also comprise nonmineral impurities, especially carbon compounds. Preferred catalyst raw materials are those bentonites having a total carbon content of <3%, preferably <1%, more preferably <0.5%.

The sheet silicate is acid-activated for the production of the catalyst of the invention. For this purpose, the sheet silicate is treated either in piece form or in powder form in a manner known per se with mineral acids, for example hydrochloric acid, sulfuric acid or nitric acid. Also possible is activation in organic acids, such as formic acid or acetic acid.

Sheet silicates that have already been acid-activated by the manufacturer, also called clay minerals, are sold, for example, under the “K10” or “KSF” or “Tonsil” name by Clariant.

For production of the shaped catalyst bodies of the invention, water and any binder are added, and the mixture is shaped with a corresponding extrusion tool (die). Suitable dies for production of the shaped catalyst bodies of the invention have openings corresponding to the cross section of the shaped catalyst bodies. In the extrusion, it is possible to add auxiliaries known to the person skilled in the art, such as binders, lubricants, pore formers and/or solvents.

In a preferred execution, the catalyst may be processed directly without the use of binders, lubricants or pore formers by the addition of a solvent, for example water, dilute mineral acids, aqueous acid solutions or organic solvents.

The catalyst is generally dried at temperatures of 30° C. to 200° C. and standard pressure, but drying is optionally also possible under reduced pressure. Subsequently, the catalyst can be calcined at temperatures of 150° C. to 800° C., preferably 250° C. to 600° C.

Useful pretreatments of the catalyst prior to use in the polymerization reaction include, for example, drying with inert gases heated to 80 to 200° C., preferably to 100 to 150° C., for example air or nitrogen.

Fixed beds composed of the shaped catalyst bodies of the invention generally have an apparent density of 600 to 800 g/I, preferably 650 to 770 g/I, where apparent density is determined as described below in the examples.

Suitable telogens in the production of PTHF esters are carboxylic anhydrides and/or carboxylic anhydride/carboxylic acid mixtures. Among these, preference is given to aliphatic and aromatic poly- and/or monocarboxylic acids or anhydrides thereof that comprise 2 to 12 carbon atoms. Examples of preferred telogens are acetic anhydride, propionic anhydride, succinic anhydride and maleic anhydride, optionally in the presence of the corresponding acids. Acetic anhydride in particular is a preferred telogen.

The PTHF acetates formed when the preferred telogens are used can be converted to PTHF by various methods (for example as described in U.S. Pat. No. 4,460,796). Other copolymers of THF can be prepared by the additional use of cyclic ethers as comonomers that can be subjected to ring-opening polymerization, preferably three-, four- and five-membered rings, such as 1,2-alkylene oxide, e.g. ethylene oxide or propylene oxide, oxetane, substituted oxetanes, such as 3,3-dimethyloxetane, and THF derivatives such as 3-methyltetrahydrofuran, 3,3-dimethyltetrahydrofuran or 3,4-dimethyltetrahydrofuran, particular preference being given to 3-methyltetrahydrofuran.

The telogen and if desired the comonomer are appropriately added to the polymerization dissolved in THF. Since the telogen leads to chain termination or to chain transfer in the polymerization, it is possible to control the average molecular weight of the polymer via the amount of telogen used. The more telogen is present in the reaction mixture, the lower the average molecular weight of PTHF or of the PTHF derivative in question will be. Depending on the telogen content of the polymerization mixture, it is possible to specifically produce PTHF, the PTHF derivatives in question or THF copolymers with average molecular weights of 250 to 10 000 daltons. The process of the invention is preferably used to produce PTHF, the PTHF derivatives in question or THF copolymers with average molecular weights of 500 to 5000 daltons, more preferably of 650 to 4000 daltons.

The polymerization is generally conducted at temperatures of 0 to 80° C., preferably of 25° C. up to the boiling temperature of THF. The pressure employed is generally not critical for the outcome of the polymerization, and therefore the pressure employed is generally atmospheric pressure or below the autogenous pressure of the polymerization system. An exception to this is formed by the copolymerization of THF with the volatile 1,2-alkylene oxides, which is advantageously performed under pressure. The pressure is typically 0.1 to 20 bar, preferably 0.5 to 2 bar.

In order to avoid the formation of ether peroxides, the polymerization is advantageously conducted under an inert gas atmosphere. Inert gases used may, for example, be nitrogen, carbon dioxide or the noble gases; preference is given to using nitrogen.

It is particularly advantageous to perform the polymerization under a hydrogen atmosphere. This embodiment brings about a particularly low color number of the polymers formed. The partial hydrogen pressure may be chosen between 0.1 and 50 bar. Doping of the polymerization catalyst with transition metals or mixing of the polymerization catalyst with a transition metal catalyst makes it possible to further improve the color number in the case of performance of the polymerization in the presence of hydrogen. Transition metals used are the elements of groups 7 to 10 of the Periodic Table, for example ruthenium, rhenium, nickel, iron, cobalt, palladium and/or platinum.

The process of the invention can be performed batchwise or continuously; the continuous mode of operation is generally preferred for economic reasons.

In the continuous mode of operation, the reaction can be conducted in conventional reactors or reactor arrangements suitable for continuous processes in fixed bed mode in tubular reactors or fixed bed reactors.

In fixed bed mode, the polymerization reactor can be operated in liquid phase mode, meaning that the reaction mixture is run through the reactor from the bottom upward, or in trickle mode, meaning that the reaction mixture is run through the reactor from the top downward.

The reactant mixture (feed) composed of THF and telogen and/or comonomer is fed continuously to the polymerization reactor, where the space velocity on the catalyst is 0.01 to 2.0 kg THF/(1 h), preferably 0.02 to 1.0 kg THF/(1 h) and more preferably 0.04 to 0.5 kg THF/(1 h).

In addition, the polymerization reactor can be operated in straight pass, i.e. without product recycling, or in circulation, meaning that a portion of the polymerization mixture leaving the reactor is circulated. In circulation mode, the ratio of circulation to feed is not more than 150:1, preferably less than 100:1 and preferably less than 60:1.

The concentration of the carboxylic anhydride used as telogen in the reactant mixture fed to the polymerization reactor is between 0.03 and 30 mol %, preferably 0.5 to 20 mol %, more preferably 1 to 12 mol %, based on the THF used. If a carboxylic acid is used additionally, the molar ratio in the feed is typically 1:20 to 1:20 000, based on carboxylic anhydride used.

If comonomers are additionally used, the molar ratio in the feed is typically 0.1 to 60 mol %, preferably 0.5 to 50 mol %, more preferably 2 to 40 mol %, based on THF used.

The particularly preferred PTHF acetates or THF copolymer acetates can be worked up by methods known per se. For example, after distillative removal of unconverted THF and any acetic anhydride, acetic acid and comonomer, the PTHF acetate or THF copolymer acetate obtained can be transesterified under base catalysis with methanol to give PTHF or THF copolymer and methyl acetate.

If desired, it is then possible to remove low molecular weight PTHF and/or tetrahydrofuran copolymer of average molecular weight from 200 to 700 daltons by distillation. It is typically possible here also to remove low molecular weight cyclic oligomers by distillation. The distillation residue that remains here is PTHF or THF copolymer having average molecular weights of 650 to 10 000 daltons.

The shaped catalyst bodies of the invention, after use in a PTHF method run batchwise or continuously, can be regenerated, for example by thermal treatment as described in EP-A-0 535 515, and/or by washing the catalyst with aqueous and/or organic solvents.

The invention also relates to the use of shaped catalyst bodies in trilobal form, especially in the above-described specific trilobal form, for production of polytetrahydrofuran, polytetrahydrofuran copolymers or the mono- or diesters thereof.

The invention is elucidated in detail by the examples below.

### EXAMPLES

### Determination of Apparent Density:

A defined amount of product (700-900 ml) is introduced via a dosing feeder into a 11 measuring cylinder (not conical; diameter about 6 cm). The measuring cylinder stands on a tamped volumeter (e.g. STAV 2003 from JEL). As soon as the first material falls into the measuring cylinder, the tamped volumeter starts up. After 330-370 impacts, all the material must be in the measuring cylinder; after 700 impacts, the tamped volumeter automatically shuts down. The apparent density is the quotient of the mass of catalyst introduced and the volume of the catalyst after tamping.

### Determination of Pressure Drop:

Pressure drop is determined in a vertical tube of diameter 100 mm with a sightglass and distributor plate. About 1.0 l of catalyst is introduced, so as to result in an initial bed height of about 145 mm. A nitrogen gas stream is passed through the catalyst-filled tube. The superficial velocity is varied over a range of about 5 to 70 cm/s, and the respective pressure differential is measured.

The measurements of pressure drop as a function of superficial velocity are normalized to the initial bed height of 145 mm and plotted on a graph. This is used to ascertain the pressure differential of the bed at a superficial velocity of 50 cm/s.

### Catalyst Production:

100 kg of K10 activated bleaching earth (from Clariant) was milled together with 63 l of demineralized water in a Mixmuller, and results in the extrusion mass. Depending on the K10 batch, the amount of water may vary somewhat.

### Examples 1 and 2 and Comparative Examples 1 and 2

### Example 1

This extrusion mass is processed to extrudates in trilobal form through dies according to FIG. 1 in a Sela extruder, then dried at 120° C. for 2 h and finally calcined at 450° C. in a muffle furnace under air for 2 h.

### Example 2

The extrusion mass from example 1 is processed to extrudate in trilobal form through dies according to FIG. 2 in a Sela extruder, then dried at 120° C. for 2 h and finally calcined at 450° C. in a muffle furnace under air for 2 h.

### Comparative Example 1

The extrusion mass from example 1 is extruded to extrudates having a diameter of 1.6 mm in a Sela extruder, then dried at 120° C. for 2 h and finally calcined at 450° C. in a muffle furnace under air for 2 h.

### Comparative Example 2

The extrusion mass from example 1 is extruded to give five-arm star extrudates having a diameter of 3 mm in a Sela extruder, then dried at 120° C. for 2 h and finally calcined at 450° C. in a muffle furnace under air for 2 h.

### Comparative Example 3

The extrusion mass from example 1 is extruded to extrudates having a diameter of 2.5 mm, then dried at 120° C. and finally calcined at 450° C. under air.

The samples thus obtained have the properties according to table 1 below:

TABLE 1

| | | | Comp. ex- | Comp. ex- | Comp. ex- |
|---|---|---|---|---|---|
| | Example 1 | Example 2 | ample 1 | ample 2 | ample 3 |
| Cross-sec- | Trilobes | Trilobes | Cylindrical | Stars | Cylindrical |
| tional shape | according | according | 1.6 mm | | 2.5 mm |
| | to FIG. 1 | to FIG. 2 | extrudates | | extrudates |
| Apparent den- | 668 | 606 | 670 | 572 | 689 |
| sity in g/l | | | | | |
| Pressure drop | 2.4 | n.d. | 3.0 | 2.8 | 2.3 |
| in mbar at | | | | | |
| 50 cm/s | | | | | |

It is apparent that the trilobes according to example 1, with the same apparent density of about 670 g/I, have a much smaller pressure drop than the reference extrudates according to comparative example 1.

It is also apparent that the trilobes according to example 2 and the stars have a much lower apparent density, such that, for the same catalyst volume, there is much less active material available in the reactor.

### Examples 3 and 4 and Comparative Examples 4 to 6

Extrusion to trilobal form and to the reference geometry (cylindrical 1.6 mm extrudates) were conducted in multiple batches each of 300 kg, in each case with subsequent drying at 120° C. and calcination at 450° C. The extrusion mass was milled in the Mix Muller at a power consumption of about 30 kW; the amount of water was added within 30 min. Drying was effected on a belt drier, calcination in a rotary tube with a dwell time of 1.5 h. The resulting samples varied in apparent density.

TABLE 2

| | | | Comp. ex- | Comp. ex- | Comp. ex- |
|---|---|---|---|---|---|
| | Example 3 | Example 4 | ample 4 | ample 5 | ample 6 |
| Cross-sec- | as in ex. 1 | as in ex. 1 | as in comp. | as in comp. | as in comp. |
| tional shape | (Trilobes | (Trilobes | example 1 | example 1 | example 1 |
| | according to | according to | (reference | (reference | (reference |
| | FIG. 1) | FIG. 1) | 1.6 mm) | 1.6 mm) | 1.6 mm) |
| Apparent den- | 660 | 753 | 670 | 694 | 745 |
| sity in g/l | | | | | |
| Pressure drop | 2.4 | 3.7 | 3.0 | 4.0 | 5.0 |
| in mbar at | | | | | |
| 50 cm/s | | | | | |

The pressure drops ascertained for the trilobes, even at apparent density 750 g/l, are still below 4 mbar at 50 cm/s. This pressure drop is already attained at 700 g/I in the case of the reference geometry. It follows from this that, when trilobes are used, it is possible to utilize a greater mass of catalyst for the same reactor volume without occurrence of problems as a result of a higher pressure drop.

### PTHF Synthesis

### Example 6

Before use in the polymerization reaction, the catalyst is dried in a crystal oven under inert gas atmosphere at temperatures of 100 to 180° C. The reaction is conducted in a fixed bed reactor in liquid phase mode at ambient pressure. The starting mixture of THF and telogen is fed into the polymerization reactor over the catalyst continuously at a space velocity of 0.04 to 0.5 kg THF/L*h. In addition, the reactor is operated in circulation mode, meaning that a portion of the polymerization mixture leaving the reactor is recycled. In this mode of operation, the ratio of recycle stream to feed stream is not more than 150:1. In order to avoid the formation of THF peroxides, the polymerization is conducted under inert gas atmosphere such as nitrogen or argon.

A solution of 3.8% acetic anhydride in THF was pumped at 40° C. and under inert gas atmosphere through 200 ml of the catalyst (starting weight 120 g, predried at 180° C.). The catalyst (made up with glass beads for the same charge with different apparent densities) took the form of a fixed bed in a 470 ml tubular reactor (internal diameter: about 40 mm). The reactor was operated with a product recycle rate of about 1 I/min and a recycle stream:feed stream ratio of 100:1. In order to eliminate unreacted THF and the acetic anhydride, the resultant crude product was subjected to distillation under reduced pressure, initially at 55° C. and 1 mbar for 30 minutes, followed by 155° C. and 1 mbar for 30 minutes. The conversion, expressed in terms of the evaporation residue (ER) and the conversion of acetic anhydride obtained via the esterification value determined by titrimetry, and the molar masses (MW) obtained via NIR measurement are reported in table 3. This results in a figure for the THF converted to high molecular weight PTHF. The continuous reaction was in each case conducted at the same catalyst load until a stable average value was obtained, the standard deviation of which was less than ±1% of the value.

TABLE 3

| | | Comp. | Comp. |
|---|---|---|---|
| | Example 1 | example 1 | example 3 |
| Cross-sectional | Trilobes | Cylindrical | Cylindrical |
| shape | according to | 1.6 mm | 2.5 mm |
| | FIG. 1 | extrudates | extrudates |
| ER in % | 62 | 62 | 61 |
| Ac₂O conversion | 94 | 94 | 94 |
| in % | | | |
| MW in g/mol | 1700 | 1690 | 1684 |
| THF conversion | 60 | 60 | 59 |
| in % | | | |

It is apparent that the trilobes according to example 1 and the reference extrudates according to comparative example 3 do have similar values for apparent density and pressure drop. However, the activity of the extrudates according to comparative example 3 is lower than that of the trilobes of the invention.

1-15. (canceled)

16. A process for producing polytetrahydrofuran, polytetrahydrofuran copolymers or the mono- or diesters thereof, comprising:
polymerizing tetrahydrofuran and any comonomers over shaped catalyst bodies comprising an acid-activated sheet silicate, wherein the shaped catalyst bodies have a shape of trilobes, wherein a cross section of the trilobes is bounded by three convex curves that each make contact with a circle of diameter d that circumscribes the cross section and have three points of intersection within said circle, where a distance a from any two points of intersection is 0.5 to 0.65 times the diameter d of the circle that circumscribes the cross section, and the diameter d of the circle that circumscribes the cross section is 2 to 5 mm.

17. The process according to claim 16, wherein the distance a is 0.5 to 0.6 times the diameter d.

18. The process according to claim 16, wherein the cross section of the trilobes has threefold rotational symmetry.

19. The process according to claim 16, wherein the acid-activated sheet silicate is montmorillonite-saponite group or palygorskite-sepiolite group.

20. The process according to claim 19, wherein the acid-activated sheet silicate is a bentonite.

21. The process according to claim 16, wherein the shaped catalyst bodies are in a fixed catalyst bed.

22. The process according to claim 21, wherein the polymerization is conducted in liquid phase mode or trickle mode.

23. A shaped catalyst body, comprising:
an acid-activated sheet silicate in a form of trilobes, wherein a cross section of the trilobes is bounded by three convex curves that each make contact with a circle of diameter d that circumscribes the cross section and have three points of intersection within said circle, where a distance a from any two points of intersection is 0.5 to 0.65 times the diameter d of the circle that circumscribes the cross section, and the diameter d of the circle that circumscribes the cross section is 2 to 5 mm.

24. The shaped catalyst body according to claim 23, wherein the cross section of the trilobes has threefold rotational symmetry.

25. The shaped catalyst body according to claim 23, wherein the acid-activated sheet silicate is montmorillonite-saponite group or palygorskite-sepiolite group.

26. The shaped catalyst body according to claim 25, wherein the acid-activated sheet silicate is a bentonite.

27. The shaped catalyst body according to claim 23, which are extrudates having a ratio of length:diameter d of 20:1 to 0.5:1.

28. The shaped catalyst body according to claim 23, configured for production of polytetrahydrofuran, polytetrahydrofuran copolymers and mono- or diesters thereof.

29. A process, comprising:
producing polytetrahydrofuran, a polytetrahydrofuran copolymer, or a mono- or diester thereof, in a reaction catalyzed by the shaped catalyst body according to claim 23.

30. The shaped catalyst body according to claim 23, wherein the distance a is 0.5 to 0.6 times the diameter d.

31. The shaped catalyst body according to claim 28, wherein the extrudates have a ratio of length:diameter d of 5:1 to 1:1.
